(19) United States
(12) Patent Application Publication
(10) Pub. No.: US 2001/0015011 A1
(43) Pub. Date: Aug. 23, 2001

(54) Arcing fault detection circuit breaker with strain relieved electrical tap

(76) Inventors: Frederick W. Glabau, Kensington, CT (US); Raymond K. Seymour, Plainville, CT (US)

Correspondence Address: CANTOR COLBURN, LLP, 55 GRIFFIN ROAD SOUTH, BLOOMFIELD, CT, 06002

(21) Appl. No.: 09/681,513

(22) Filed: Apr. 19, 2001

Related U.S. Application Data
(62) Division of application No. 09/470,342, filed on Dec. 22, 1999.

(51) Int. Cl. H01H 73/00

(52) U.S. Cl. 29/868; 335/18; 29/860; 29/867

(57) ABSTRACT

An arcing fault detection circuit breaker (10) with strain relieved electrical tap comprises an electronic trip unit (68) to detect arcing from line (30) to neutral (80). Arcing is detected by measuring the voltage drop across a bimetal (32). Voltage drop across the bimetal (32) is sensed by a twisted pair conductor (62), which is electrically connected across the bimetal (32). The bimetal (32) has a fixed end (34) and an opposing free end (54), which is free to move. A strain relief element in the form of stepped eyelet (92) is used to affix one conductor (64) of the twisted pair conductor (62) to the bimetal (32) so that the conductor (64) remains affixed to the free end (54) of the bimetal (32) during movement of the bimetal (32).

### CROSS REFERENCE TO RELATED APPLICATIONS

This application is a Divisional of pending U.S. application Ser. No. 09/470,342 filed on Dec. 22, 1999, which is hereby incorporated by reference in its entirety.

### BACKGROUND OF INVENTION

The present invention relates generally to a circuit breaker and, more particularly, to a method of providing reliable strain relief when interconnecting an electrical tap with a bimetal in an arcing fault detection circuit breaker.

Arc fault circuit breakers typically comprise a pair of separable contacts that open (trip) upon sensing an arcing current from line to ground, and/or from line to neutral. Arc fault circuit breakers typically use a differential transformer to measure arcing from line to ground. Detecting arcing from line to neutral is accomplished by detecting rapid changes in load current by measuring voltage drop across a relatively constant resistance, usually a bimetallic element (bimetal). Additionally, during over current conditions (i.e., above rated current) the bimetal heats up and flexes a predetermined distance to engage a primary tripping mechanism and trip the circuit breakerComponents of arc fault circuit breakers are generally assembled into separate compartments as defined by their function. More specifically, mechanical components (e.g., load current carrying and switching components) of each pole are assembled into mechanical compartments, while the current sensing components are assembled into an electronics compartment. In order to connect the compartments, the load current of each pole must be routed from the mechanical compartments into the electronics compartment, through appropriate current sensing devices, and back into the mechanical compartments. Additionally, conductors or sensing lines (e.g., wires connected to the bimetal), must also be routed from the mechanical compartment into the electronics compartment.

The bimetal has a dual function. First, it engages the circuit breaker's primary tripping mechanism to trip the circuit breaker during over current conditions (e.g., above its rated current of 10, 15 or 20 amps). Second, it also detects multiple, instantaneous, high-current arcing (e.g., 70 to 500 amps or more) from line to neutral.

For the first function, the bimetal is constructed of a pair of dissimilar metallic strips having different coefficients of expansion. When the bimetal conducts current, the dissimilar metallic strips heat up and expand at different rates, causing the bimetal to flex proportionally to the current conducting through it. The bimetal is calibrated to flex a predetermined distance during over current conditions to engage and activate the tripping mechanism. The movement of the bimetal can be vigorous. This vigorous movement coupled with temperature increases during short circuit conditions subjects any connections to the free end of the bimetal to extreme conditions.

The second function utilizes the relatively constant resistance of the bimetal. The voltage drop across the bimetal is sensed by sensing lines and processed by circuitry (e.g., a printed circuit board) located in the electronics compartment to detect the arcing. When voltage drops indicative of arcing are detected, the circuitry generates a trip signal to activate the tripping mechanism and trip the circuit breaker. However, voltage drops indicating an arc fault are small and rapid, and can be imitated by electromagnetic interference (EMI) in the sensing lines. If the sensing lines are not properly protected, EMI may cause the sensing circuitry to trip the circuit breaker without the occurrence of arcing (false trip).

In order to reduce the effects of EMI on prior art circuit breakers a pair of sensing lines (e.g., wires) are first connected to the printed circuit board at assembly. The lines are then twisted together to offset the effects of EMI before they are routed through appropriate openings into the mechanical compartment, where they are connected across the bimetal. The sensing lines are commonly constructed of stranded wires covered with an insulating jacket, which are connected to the rigid bimetal by soldering, welding, brazing or other like fashion. However, it is difficult to affix a stranded wire conductor to the bimetal without severing the strands. In addition, movement of the free end of the rigid bimetal, to which one of the sensing lines is attached, the individual strands, which make up the conductor, are at a risk for breakage. If the conductor does break, the result would be the severing of an essential electrical connection necessary for successful operation of the circuit breaker.

It is therefore desirable to provide a reliable method of interconnecting an electrical tap to the bimetal with substantial strain relief so that the electrical connection remains in tact during the vigorous movement of the bimetal when exposed to short circuit conditions.

### SUMMARY OF INVENTION

In an exemplary embodiment of the invention, an improved molded case circuit breaker trip unit having arcing fault response includes a bimetal having a first end and an opposing second end. The first end of the bimetal is connected to a conducting strap and the second end of the bimetal is free to move. A twisted pair conductor includes a first conductor having a first end and an opposing second end, and a second conductor having a first end and an opposing second end. The first end of the first conductor is electrically connected to the first end of the bimetal and the second end of the first conductor is electrically connected a sensing component. The first end of the second conductor is assembled in a strain relief element prior to being electrically connected to the second end of the bimetal and the second end of the second conductor is electrically connected to the sensing component.

### BRIEF DESCRIPTION OF DRAWINGS

FIG. 1 is a perspective view of a residential circuit breaker of the present invention;

FIG. 2 is an exploded perspective view of the mechanical compartment of the circuit breaker shown in FIG. 1;

FIG. 3 is an exploded perspective view of the electronic compartment of the circuit breaker shown in FIG. 1;

FIG. 4 is a rear plan view of a bimetal shown with a conductor attached using a stepped eyelet of the present invention;

FIG. 5 is a side plan view of the bimetal shown in FIG. 4;

FIG. 6 is a sectional view of the stepped eyelet taken along lines 6-6 in FIG. 4 shown with the conductor removed;

FIG. 7 is a top view of the stepped eyelet of FIG. 6 viewing from line 7-7;

FIG. 8 is a bottom view of the stepped eyelet of FIG. 6 viewing from line 8-8;

FIG. 9 is a front view of the conductor prior to insertion into the stepped eyelet; and

FIG. 10 is a sectional view of the stepped eyelet taken along lines 6-6 in FIG. 4.

### DETAILED DESCRIPTION

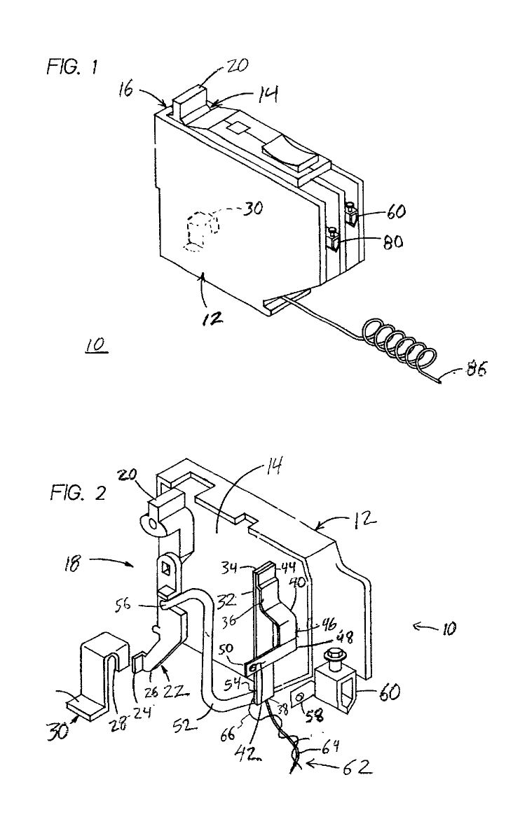

Referring first to FIG. 1, a circuit breaker with arcing fault detection is shown generally at 10. The circuit breaker 10 has an insulating housing 12. The housing 12 comprises a mechanical compartment 14 and an electronic compartment 16 which are secured together with permanent fasteners (not shown). A manual trip/reset switch 20 extends from a top portion of housing 12. A neutral current from the load connects to a neutral terminal 80, and conducts along the neutral current carrying components within housing 12 to neutral return wire 86. A load current from a source connects to a line terminal 30 within housing 12, and conducts along current carrying and switching components within housing 12 to a load terminal 60.

Referring to FIG. 2, the mechanical compartment 14 is shown with electronics compartment 16 removed. Mounted in the mechanical compartment 14 are a plurality of load current carrying and switching components 18 including trip/reset switch 20 pivotally connected to a moveable contact arm 22 to which a movable contact 24 is mounted on a first distal end 26. The moveable contact 24 is forcibly biased against a stationary contact 28, which is affixed to line terminal 30, to provide electrical continuity for the load current. Manual trip/reset switch 20 is pivotally attached to housing 12 and contact arm 22, thus allowing the manual separation of movable contact 24 from stationary contact 28 to stop the flow of load current through breaker 10. Trip/reset switch 20 and contact arm 22 are also arranged to reset fixed and movable contacts 24, 28 to a closed position after contacts 24, 28 have been separated due to the detection of an arc fault.

Also provided within mechanical compartment 14 is a bi-metal resistor 32 that is affixed at a first (fixed) end 34 to an L-shaped strap 36, which, in turn, is attached to the housing 12. A second (free) end 38 of the bimetal 32 is unattached. The L-shaped strap 36 includes a vertical strap 40 and a horizontal strap extension 42. The vertical strap 40 includes a first end 44 that is connected to the first end 34 of the bimetal 32. The vertical strap 40 is shaped so that when affixed to the bimetal, only the first end 44 of the vertical strap 40 makes physical contact with the bimetal 32. When the vertical strap 40 is attached at the first end 44 to the first end 34 of the bimetal 32, the remaining portion of the vertical strap 40 is bent and shaped so that a physical gap separates the bimetal 32 and the vertical strap 40. The vertical strap 40 also has a second end 46, which is also physically separated from the bimetal 32. The L-shaped strap 36 further includes the horizontal strap extension 42 having a first end 48 and an opposing second end 50. The horizontal strap extension 42 is generally rectangular in shape. The second end 46 of the vertical strap 40 is connected to the first end 48 of the horizontal strap extension 42 so that the vertical strap 40 and strap extension 42 are generally perpendicular to one another, with the horizontal strap extension 42 extending from the mechanical compartment 14 into the electronic compartment 16. The connections between bimetal 32, vertical strap 40, and strap extension 42 can be by mechanical fastening, welding, soldering or the like.

A braided shunt conductor 52 is affixed at a first end 54 to the free end 38 of the bimetal 32. This connection is accomplished by soldering, welding, brazing or similar process. A second end 56 of the shunt conductor 52 is similarly affixed to the moveable contact arm 22.

In operation, a load current is supplied to the line connection 30. The load current flows through the stationary contact 28 to the movable contact 24, through the moveable contact arm 22, the shunt conductor 52 into the bimetal 32 and the L-shaped strap 36. It is at this point that the current passes from the mechanical compartment 14 into the electronic compartment 16. Load terminal 58 also extends from the mechanical compartment 14 into the electronic compartment 16, after the current circulates through the electronic compartment, the load current path returns to the mechanical compartment 14 through the load terminal 58 and out through a load terminal 60 to the load.

The horizontal strap extension 42 connected to the vertical strap 40 of the L-shaped strap 36 angles away from the bimetal 32 so that the attached horizontal strap extension 42 represents the voltage at the first end 34 of the bimetal 32. In an exemplary embodiment, a twisted pair conductor 62 comprising a first conductor 64 and a second conductor 66 are electrically connected to the bimetal 32. The first conductor 64 is electrically connected to the first end 34 of the bimetal 32 at the horizontal strap extension 42 and the second conductor 66 is electrically connected to the free end 38 of the bimetal 32 in a manner described in further detail hereinafter. The twisted pair conductor 62 is then fed into the electronic compartment 16, allowing the necessary electrical interconnections between the mechanical compartment 14 and the electronic compartment 16 to be completed in the electronic compartment 16.

Bimetal 32 has a dual function. It engages and activates the primary tripping mechanism (not shown) for tripping the circuit breaker 10 during over current conditions (e.g., above the circuit breaker's rated current of, for example, 10 amps 15 amps or 20 amps). By utilizing the different expansion rates of its bimetal construction, the bimetal is calibrated to flex a predetermined distance at the circuit breaker's rated current. Once the rated current is exceeded, any additional flexing of the bimetal will engage and activate the tripping mechanism of the circuit breaker. Additionally, bimetal 32 provides relatively constant resistance in series with the current path. Therefore, the voltage drop across the bimetal is indicative of the current in the current path. Arcing from line to neutral results in rapid current changes (e.g., 70 to 500 amps peak) in the current path, which can be sensed via first conductor 64 and second conductor 66 as rapidly changing voltage across the bimetal.

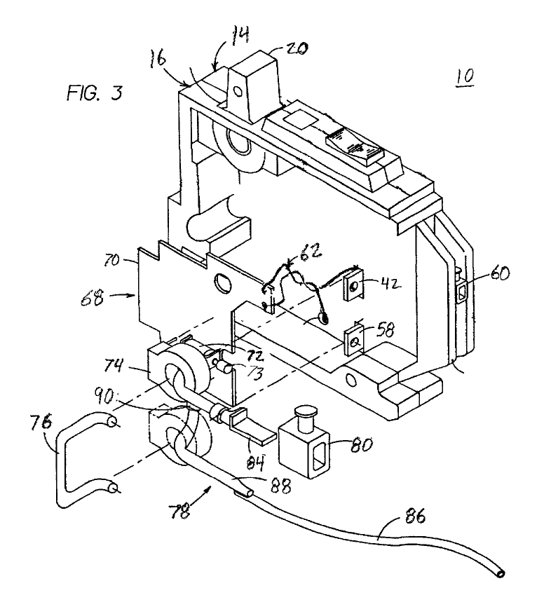

Referring to FIG. 3, circuit breaker 10 also includes a variety of current sensing components 68 that are mounted in the electronic compartment 16. Current sensing components 68 include a circuit board 70 which is electrically connected to a solenoid 72 along with a current sensing transformer 74. The twisted pair conductor 62 is electrically interconnected to the circuit board 70 which is utilized to sense the voltage across the bimetal 32 (FIG. 2) and generates a trip signal to actuate the solenoid 72 in response to a rapid voltage change indicative of arcing.

The load current path is completed by electrically interconnecting the horizontal strap extension 42 and the load terminal 58 to respective distal ends of a wire connector 76. The wire connector 76 can be formed from various suitable conductive materials, e.g., insulated wire, rectangular formed magnetic wire, square formed magnetic wire, or insulated sleeve covered braided copper. The wire connector 76 is routed through the current sensing transformer 74 so that the flow of the load current through the transformer 74 is in a known direction.

Also housed in the electronic compartment 16 are the neutral current carrying components 78 which are electrically connected to form a neutral current path for the neutral current. The neutral current path begins at a neutral terminal 80 where the neutral current enters the electronic compartment 16. The neutral terminal 80 secures a neutral lead (not shown), which is connected to the load (not shown), against neutral terminal 84 to provide electrical continuity thereto. The neutral terminal 80 is electrically connected to a neutral return wire 86 via a copper braid 88. An insulating sleeve 90 surrounds a portion of the copper braid 88 and provides electrical insulation between the copper braid 88 and the circuit board 70. The copper braid 88 is routed through the current sensing transformer 74 such that the flow of the neutral current through the transformer 74 is in the opposite direction of the flow of the load current through the wire connector 76.

Both the copper braid 88 of the neutral current path and the wire connector 76 of the load current path are routed through the current sensing transformer 74 to sense arcing from line to ground as is well known. This is accomplished by routing the flow of neutral current through the transformer 74 in the opposite direction to the flow of the load current. The total current flow through the transformer 74 thus cancels unless an external ground fault current is caused by arcing from line to ground. The resulting differential signal, sensed by the transformer 74 is then processed by the circuit board 70.

Solenoid 72 comprises trip rod 73 for engaging the trip mechanism (not shown) to pivot the trip/reset switch 20 and contact arm 22 (FIG. 2) in response to the trip signal, and provides the means to trip the circuit breaker 10 under arc fault conditions. That is, when an arc fault is sensed, circuit board 70 generates a trip signal to actuate solenoid 72, which extends the trip rod 73 to activate the trip mechanism which pivots the trip/reset switch 20 and contact arm 22 to separate contacts 24 and 28 and thereby opens the load current path.

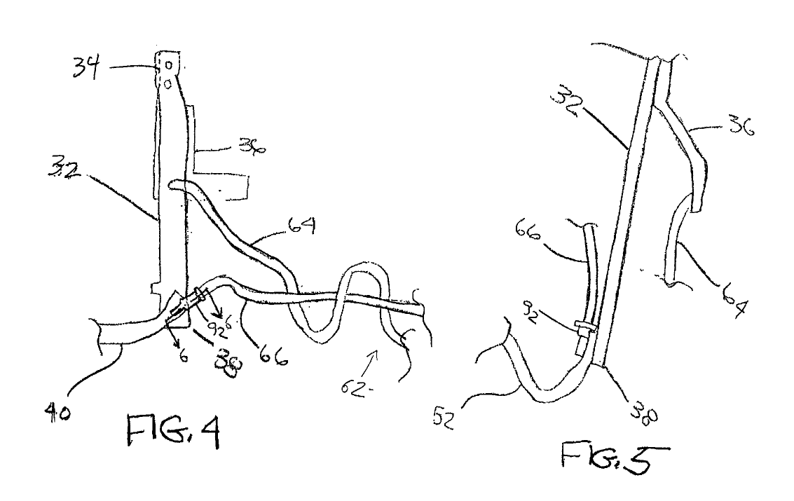

As described, arc fault circuit breakers typically use a differential transformer to measure arcing from line to ground. Detecting arcing from line to neutral is accomplished by detecting rapid changes in load current by measuring voltage drop across the bimetal 32. Prolonged overcurrent conditions heat the bimetal 32 causing it to bend and flex about the first end 34, which is fixed, as best seen in FIG. 4 and FIG. 5. The point of maximum deflection of the bimetal 32 occurs at the location most removed from the first or fixed end 34. This location is the free end 38 of the bimetal 32. Therefore, second conductor 66 of twisted pair conductor 62, which is attached to the free end 38 of the bimetal will likewise be exposed to the maximum deflection. To provide strain relief to the connection between conductor 66 and bimetal 32, conductor 66 is attached to bimetal 32 using a strain relief element in the form of a double stepped eyelet 92 of the present invention.

As shown in FIG. 6, the double stepped eyelet 92 includes an upper barrel 94 having a first end 96 and an opposing second end 98, wherein the upper barrel 94 is generally cylindrical in shape. Extending concentrically through the geometric center of the upper barrel 94 from the first end 96 to a point short of the second end 100 is a first inlet 102. The upper barrel 94 has an outer surface 104 and an inner surface 106. Where the difference between the outer surface 104 and the inner surface 106 defines a material thickness 108.

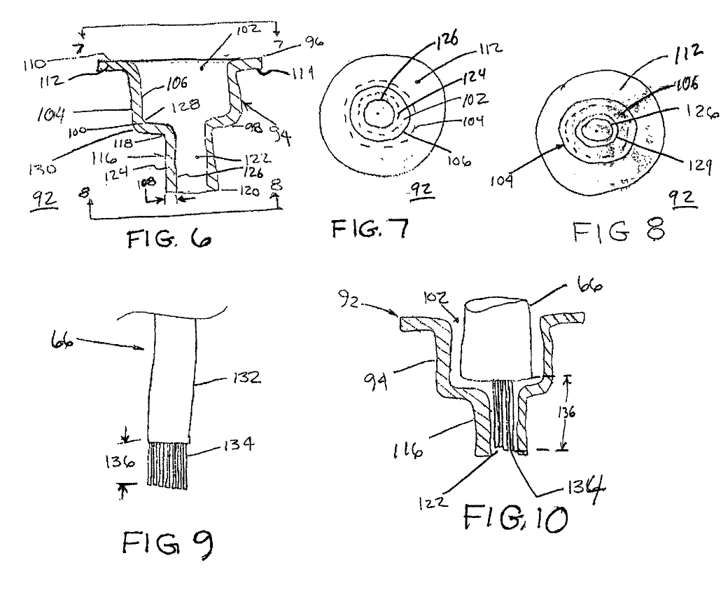

Located in the same plane as the first end 96 of the upper barrel 94 is a top surface 110 of a border 112. The border 112 extends substantially perpendicular to the upper barrel 94 and extends radially outward away from the center, so that the inner surface 106 of the upper barrel 94 forms the top surface 110 of the border 112 and the outer surface 104 of the upper barrel 94 forms a bottom surface 114 of the border 112. The difference between the top surface 110 and the bottom surface 114 being the material thickness 108. Wherein the top surface 110 and the bottom surface 114 are generally parallel to one another. FIGS. 7-8 show the border 112 as cylindrical in shape, however other border shapes or no border at all can be utilized. As will later be described, the border 112 is used to guide the second conductor 66 (FIG. 5) into the first inlet 102.

Referring again to FIG. 6, at the second end 98 of the upper barrel 94 extends a lower barrel 116 which is generally cylindrical in shape, wherein the diameter of the upper barrel 94 is greater than the diameter of the lower barrel 116. The lower barrel 116 comprises a first end 118 and an opposing second end 120. Extending through the lower barrel 16 and the material thickness 108 of the upper barrel 94 is a second inlet 122, wherein the diameter of the first inlet 102 is greater than the diameter of the second inlet 122. The second inlet 122 is concentric with the first inlet 102 and extends from the point short of the second end 100 of the upper barrel 94 through to the second end 120 of the lower barrel 116, so that the first inlet 102 feeds into the narrower second inlet 122. The lower barrel 116 has an outer surface 124 and an inner surface 126. The material thickness 108 remains substantially constant throughout the stepped eyelet 92 so that an inner step 128 is created at the intersection of the first inlet 102 and the second inlet 122 and an outer step 130 is created at the intersection of the upper barrel 94 and the lower barrel 116 wherein the difference between the outer step 130 and the inner step 128 and the difference between the outer surface 124 of the lower barrel 116 and the inner surface 126 of the lower barrel 116 is the material thickness 108.

As shown in FIG. 9, the second conductor 66 comprises an insulating jacket 132 covering a quantity of individual stands of wire 134. Therefore, when the insulating jacket 132 is stripped away strands of wire 134 are exposed. Prior to connection to the bimetal 32, the second conductor 66 is prepared as shown in FIG. 9. That is, the insulating jacket 132 is stripped away leaving a length of exposed strands of wire 136.

Referring to FIG. 10, connection between second conductor 66 and stepped eyelet 92 is accomplished by feeding the second conductor 66 into the first inlet 102 of the stepped eyelet 92 with the length of exposed strands of wire 136 leading. The inside diameter of lower barrel 116 is greater than the outside diameter of the exposed strands 134, and less than the outside diameter of the insulating jacket 132. The strands of wire 134, therefore, are capable of passing through the second inlet 122 while the insulating jacket 132 is not. The first inlet 102 has a greater inside diameter than the insulating jacket 132, allowing the insulating jacket to pass through the first inlet 102. Therefore, the strands of wires 134 covered with the insulating jacket 132 are enclosed in the upper barrel 94 and the exposed strands of wire 134 are enclosed in the lower barrel 116. Preferrably, the inside diameter of the upper barrel is approximately equal to the outside diameter of the insulating jacket 132 to support the insulating jacket 132 and prevent bending of the exposed strands of wires 134.

Once the second conductor 66 is properly installed in the double stepped eyelet 92 the installed conductor is ready for attachment with the free end 38 of the bimetal 32, as is best shown by referring to FIGS. 4, 5, and 10. In an exemplary embodiment the bond is accomplished by heating the double stepped eyelet 92 when the second conductor 66 is installed in the eyelet 92. The melting temperature of the lower barrel 126 of the stepped eyelet 92 is less than the melting temperature of the bimetal 32 so that when heated, the lower barrel 126 of the stepped eyelet 92 melts and alloys with the bimetal 32 forming a solid bond. As the lower barrel 126 flattens against the bimetal 32 to form the bond, the length of exposed individual strands of wire 136 are retained in the lower barrel 126 and the strands of wire 134 with the insulating jacket 132 in place are supported in the upper barrel 94 which generally is unaffected by the bonding process. The resultant bond allows the second conductor 66 to be affixed to the bimetal 32 and provides the necessary strain relief so that when an overcurrent condition occurs, the subsequent movement of the free end 38 of the bimetal 32 will not sever the essential electrical connection with the second conductor 66.

The stepped eyelet 92 provides strain relief at the connection of the second conductor 66 to the bimetal 32. This is accomplished because the eyelet 92 retains the individual strands of the conductor 66 during the welding process, and because the eyelet 92 supports the wire and insulation at the point where the conductor 66 connects to the bimetal 32.

It will be understood that a person skilled in the art may make modifications to the preferred embodiment shown herein within the scope and intent of the claims. While the present invention has been described as carried out in a specific embodiment thereof, it is not intended to be limited thereby but is intended to cover the invention broadly within the scope and spirit of the claims.

1. An improved molded case circuit breaker trip unit having arcing fault response comprising:
a bimetal having a first end and an opposing second end, wherein the first end of the bimetal is secured and the second end of the bimetal is free to move; and
a twisted pair conductor comprising;
a first conductor having a first end and an opposing second end, and
a second conductor having a first end and an opposing second end, wherein
the first end of the first conductor is electrically connected to the first end of the bimetal and the second end of the first conductor is electrically connected to a sensing component and wherein the first end of the second conductor is assembled in a strain relief element prior to being electrically connected to the second end of the bimetal and the second end of the second conductor is electrically connected to the sensing component.

2. The improved circuit breaker trip unit according to claim 1, wherein the sensing component is an electronic trip unit.

3. The improved circuit breaker trip unit according to claim 3, wherein the electronic trip unit is utilized to sense a voltage drop across the bimetal and generate a trip signal to actuate a solenoid when a voltage drop indicative of an arc fault is sensed.

4. The improved circuit breaker trip unit according to claim 1, wherein the first and second conductor comprise an insulating jacket and a quantity of individual wires.

5. The improved circuit breaker trip unit according to claim 1, wherein the strain relief element is a double stepped eyelet.

6. The improved circuit breaker trip unit according to claim 6, wherein the double stepped eyelet comprises an upper barrel having a first inlet and an integral lower barrel having a second inlet, wherein the first inlet, having a greater diameter than the second inlet, feeds into the second inlet.

7. The improved circuit breaker trip unit according to claim 7, wherein the first inlet and the second inlet are generally cylindrical in shape.

8. The improved circuit breaker trip unit according to claim 1, wherein the insulating jacket of the first end of the second conductor is removed leaving a length of exposed stranded wires.

9. The improved circuit breaker trip unit according to claim 8, wherein a length of exposed stranded wires are enclosed in second inlet of the lower barrel and the insulating jacket with the stranded wires are enclosed in the first inlet of the upper barrel.

10. A method of assembling a second conductor of a twisted pair conductor to a second end of a bimetal used to detect arcing fault conditions in a molded case circuit breaker trip unit comprising:
preparing a first end of the second conductors by stripping away a length of an insulating jacket leaving a length of exposed stranded wires;
providing a stepped eyelet strain relief comprising an upper barrel having a first inlet and an integral lower barrel having a second inlet wherein the diameter of the first inlet is greater than the diameter of the second inlet and the first inlet advances into the second inlet;
passing the length of exposed stranded wires through the first inlet of the upper barrel and into the second inlet of the lower barrel until properly seated or until the insulating jacket is blocked from entry into the second inlet;
applying heat to the lower barrel of the stepped eyelet while pressing and holding the lower barrel against the second end of the bimetal forming a bond; and
cooling the bond to produce a solid connection.
